(19) United States
(12) Patent Application Publication
(10) Pub. No.: US 2024/0033862 A1
(43) Pub. Date: Feb. 1, 2024

(54) FERRITE-BASED STAINLESS STEEL WELDING WIRE

(71) Applicant: DAIDO STEEL CO., LTD., Nagoya-shi, Aichi (JP)

(72) Inventors: Masashi NAGAYA, Nagoya-shi, Aichi (JP); Akio UENAKA, Nagoya-shi, Aichi (JP); Hiroki HIRAI, Nagoya-shi, Aichi (JP); Osamu HARA, Nagoya-shi, Aichi (JP)

(21) Appl. No.: 18/265,615

(22) PCT Filed: Dec. 6, 2021
(86) PCT No.: PCT/JP2021/044775

§ 371 Date: Jun. 6, 2023

(30) Foreign Application Priority Data
Dec. 8, 2020 (JP) 2020-203610

(51) Int. Cl. B23K 35/30

(52) U.S. Cl. CPC B23K 35/3086

(57) ABSTRACT

Provided is a ferrite-based stainless steel welding wire that has excellent oxidation resistance properties and high temperature strength. This ferrite-based stainless steel welding wire has a composition containing, in mass %, 0.001-0.050% of C, 0.01-2.00% of Si, 0.01-1.50% of Mn, 0.030% or less of P, 0.010% or less of S, 16.0-25.0% of Cr, 0.001-0.150% of Ti, 0.020% or less of O, and 0.05% or less of N, further containing at least one selected from 0.01-1.80% of Nb, 0.01-3.60% of Mo, and 0.01-3.60% of W, and satisfying formulae (1), (2), and (3), with a balance being Fe and unavoidable impurities. Formula (1): [Nb]+[Mo]+[W]+0.25[Si]≥2.2, formula (2): [Mo]+[W]≤3.6, formula (3): [Ti]+[Al]≤0.15, where [ ] in the formulae represents the content in mass % of the element indicated in [ ].

### TECHNICAL FIELD

The present invention relates to a ferrite-based stainless steel welding wire.

### BACKGROUND ART

Ferrite-based stainless steel is less expensive than austenite-based stainless steel, can prevent thermal strain due to a low thermal expansion coefficient, and is excellent in high-temperature oxidation resistance. Therefore, the ferrite-based stainless steel is widely used for an automobile exhaust system component used in a high-temperature corrosive gas environment. Examples of the automobile exhaust system component include an exhaust manifold for collecting exhaust gas from an engine and sending the collected exhaust gas to an exhaust pipe, and a case of a converter for purifying exhaust gas by using an oxidation-reduction reaction in the presence of a catalyst. The component having such a complicated shape is assembled by welding members made of ferrite-based stainless steel. Generally, a welding wire made of ferrite-based stainless steel is used for welding the ferrite-based stainless steel.

### CITATION LIST

### Patent Literature

Patent Literature 1: JP 2003-320476A

### SUMMARY OF THE INVENTION

### Technical Problem

For example, as described in Patent Literature 1, in a ferrite-based stainless steel welding wire in related art, Nb, Mo, W, and the like are added for the purpose of improving high-temperature strength. In addition, Ti is added in order to prevent formation of Nb carbonitride, which causes a decrease in high-temperature strength due to long-term exposure. However, the addition of Mo, W, and Ti deteriorates oxidation resistance required for the welding wire.

In consideration of the above circumstances, an object of the present invention is to provide a ferrite-based stainless steel welding wire excellent in high-temperature strength and oxidation resistance.

### Solution to Problem

In the present invention, by investigating influence of various additive components in the ferrite-based stainless steel welding wire on high-temperature strength and oxidation resistance, considering a degree (extent) of the influence of various additive components on the high-temperature strength and a degree of the influence of the various additive components on the oxidation resistance, and appropriately balancing addition amounts of these additives, as an overall effect, the high-temperature strength is effectively ensured at a desired value or higher, and the oxidation resistance is also ensured.

In the present invention, addition amounts of Nb, Mo, W, and Si, which are effective in improving the high-temperature strength, are defined by the following formula (1). Since excessive addition of Mo and W deteriorates the oxidation resistance, a total amount of Mo and W is defined by the following formula (2). Since preventing deterioration of weldability is also effective in improving the high-temperature strength, a total amount of Ti and Al that affects weldability is defined by the following formula (3).

The gist of the present invention is as follows.

[1] A ferrite-based stainless steel welding wire containing, in terms of mass %: C: 0.001% to 0.050%; Si: 0.01% to 2.00%; Mn: 0.01% to 1.50%; P: 0.030% or less; S: 0.010% or less; Cr: 16.0% to 25.0%; Ti: 0.001% to 0.150%; O: 0.020% or less; N: 0.050% or less; and
one or two or more selected from Nb: 0.01% to 1.80%, Mo: 0.01% to 3.60%, and W: 0.01% to 3.60%,
with the balance being Fe and inevitable impurities, and satisfying the following formulae (1), (2), and (3), in which in the formulae, [ ] represents a content in terms of mass % of an element in [ ].

[Nb]+[Mo]+[W]+0.25[Si]≥2.2 Formula (1)

[Mo]+[W]≤3.6 Formula (2)

[Ti]+[Al]≤0.15 Formula (3)

[2] The ferrite-based stainless steel welding wire according to [1], further containing, in terms of mass %, any one or more of Cu: 0.1% to 3.0%, B: 0.01% or less, V: 0.1% to 2.0%, Ta: 0.05% to 0.50%, Zr: 0.001% to 0.010%, and Y: 0.001% to 0.010%.

### ADVANTAGEOUS EFFECT OF INVENTION

According to the present invention, a ferrite-based stainless steel welding wire excellent in high-temperature strength and oxidation resistance can be provided.

### BRIEF DESCRIPTION OF DRAWINGS

FIG. 1 is a diagram illustrating a method of preparing and collecting a test piece in Examples of the present invention.

### DESCRIPTION OF EMBODIMENTS

Ferrite-based stainless steel welding wire according to the present embodiment contains C, Si, Mn, P, S, Cr, Ti, O, N, and one or two or more selected from Nb, Mo, and W, with balance being Fe and unavoidable impurities. The Ferrite-based stainless steel welding wire may further contain Al, Cu, B, V, Ta, Zr and Y.

The reasons for limiting each chemical component in the ferrite-based stainless steel welding wire according to the present embodiment will be described in detail below. In the following description, “%” means “mass %” unless otherwise specified.

C: 0.001% to 0.050%

C is contained in an amount of 0.001% or more from the viewpoint of increasing strength of a weld zone. Since excessive addition of C causes embrittlement of the weld zone and deterioration of ductility and toughness due to formation of martensite, an upper limit thereof is 0.050%. The upper limit thereof is more preferably 0.042%.

Si: 0.01% to 2.00%

Si is an element effective in preventing grain boundary precipitation of Nb carbonitride and preventing weld cracking. In the case where Si is contained in an amount of or more, oxidation resistance can be enhanced. However, since excessive addition of Si causes degradation of toughness and a decrease in mechanical strength due to prevention of Mo solid solution, an upper limit thereof is 2.00%. The Si content is preferably 0.30% to 1.95%. The Si content is more preferably 0.30% to 1.00%.

Mn: 0.01% to 1.50%

Mn is used as a deoxidizing agent during melting. However, since excessive addition of Mn generates a sulfide and decreases toughness, the Mn content is in a range of 0.01% to 1.50%. The Mn content is preferably 0.30% to 0.90%. The Mn content is more preferably 0.40% to 0.80%.

Cr: 16.0% to 25.0%

Cr increases strength of a weld metal and in addition, improves oxidation resistance and corrosion resistance by forming a dense oxide film on the surface. In order to exhibit such characteristics, Cr is contained in an amount of 16.0% or more in the present invention. However, since excessive addition of Cr causes embrittlement, hardening, and a decrease in toughness, an upper limit thereof is 25.0%. The Cr content is preferably 16.5% to 21.0%. The Cr content is more preferably 17.0% to 19.2%.

Ti: 0.001% to 0.150%

Ti forms a carbonitride and refines a crystal grain of the weld metal. In addition, Ti promotes solid solution strengthening by Nb. However, since excessive addition of Ti deteriorates the weldability, the Ti content is in a range of 0.001% to 0.150%.

O: 0.020% or less

O forms an oxide such as SiO₂ or Al₂O₃, and deteriorates toughness. Therefore, the O content is required to be 0.020% or less.

N: 0.050% or less

N precipitates Cr nitride to form a Cr-depleted layer at the grain boundary. Accordingly, the corrosion resistance of the weld zone decreases, and therefore the N content is required to be 0.050% or less. The N content is more preferably 0.049% or less.

P: 0.030% or less, S: 0.010% or less

In the case where the amount of P and the amount of S are excessive, weld cracking is likely to occur, and the toughness of the weld zone decreases. Therefore, the P content is required to be 0.030% or less, and the S content is required to be 0.010% or less.

Nb: 0.01% to 1.80%

Mo: 0.01% to 3.60%

W: 0.01% to 3.60%

In the present embodiment, one or two or more of Nb, Mo, and W contributing to improvement of the high-temperature strength are contained.

Nb is an element effective in improving the oxidation resistance and the high-temperature strength. However, since excessive addition of Nb deteriorates weld cracking resistance, the Nb content is in a range of 0.01% to 1.80%. The Nb content is preferably 0.20% to 1.72%. The Nb content is more preferably 0.20% to 0.80%.

Mo improves strength by solid solution strengthening. However, since excessive addition of Mo causes saturation of the characteristics and an increase in cost, the Mo content is in a range of 0.01% to 3.60%. The Mo content is preferably 0.01% to 2.40%. The Mo content is more preferably 1.00% to 2.30%.

W improves strength by solid solution strengthening. However, since excessive addition of W causes saturation of the characteristics and an increase in cost, the W content is in a range of 0.01% to 3.60%. The W content is preferably 0.01% to 2.60%. The W content is more preferably 0.80% to 2.50%.

Al: 0.001% to 0.150%

Al has an effect of forming a nitride and refining the crystal grain of the weld metal. However, since excessive addition of Al causes a decrease in toughness and an increase in spatter, the Al content is preferably 0.001% to 0.150%.

Cu: 0.1% to 3.0%

Since Cu is effective in improving tensile strength and corrosion resistance, Cu can be contained as necessary. However, since excessive addition of Cu causes a decrease in toughness and ductility, the Cu content is preferably 0.1% to 3.0%.

B: 0.01% or less

Since B is effective in improving the strength by refining the crystal grain of the weld metal, B can be contained as necessary. However, since excessive addition of B causes saturation of the characteristics, the B content is preferably 0.010% or less.

V: 0.1% to 2.0%

Since V improves strength by solid solution strengthening, V can be contained as necessary. However, since excessive addition of V causes saturation of the characteristics, the V content is preferably 0.1% to 2.0%.

Ta: 0.05% to 0.50%

Since Ta is an element that stabilizes C and is effective in strengthening rust prevention, Ta can be contained as necessary. However, since excessive addition of Ta causes saturation of the characteristics, the Ta content is preferably 0.05% to 0.50%.

Zr: 0.001% to 0.010%

Since Zr is effective in improving the strength by refining the crystal grain of the weld metal, Zr can be contained as necessary. However, since excessive addition of Zr causes saturation of the characteristics, the Zr content is preferably 0.001% to 0.010%.

Y: 0.001% to 0.010%

Since Y is effective in refining crystal grains, preventing high-temperature oxidation, and improving mechanical strength, Y can be contained as necessary. However, since excessive addition of Y causes saturation of the characteristics, the Y content is preferably 0.001% to 0.010%.

[Nb]+[Mo]+[W]+0.25[Si]≥2.2 Formula (1)

Nb, Mo, W, and Si have an effect of increasing the high-temperature strength of the weld zone. Coefficients of Nb, Mo, W, and Si in the formula (1) each indicate a degree of contribution to the high-temperature strength.

In the case where the value on the left side of the formula (1) is excessively small, strength improvement due to the solid solution strengthening is insufficient. Therefore, the components are adjusted such that the value on the left side of the formula (1) is 2.2 or more. The value on the left side of the formula (1) is more preferably 2.4 or more.

[Mo]+[W]≤3.6 Formula (2)

Mo and W have an effect of increasing the high-temperature strength, but deteriorate the oxidation resistance of the weld zone. In the case where the total amount of Mo and W, that is, the value on the left side of the formula (2) is excessively large, there is a possibility that an oxide having a low melting point and high volatility is formed to cause abnormal oxidation. Therefore, the components are adjusted such that the value on the left side of the formula (2) is 3.6 or less. The value on the left side of the formula (2) is more preferably 3.4 or more.

[Ti]+[Al]≤0.15 Formula (3)

Ti and Al affect weldability. Since excessive addition of Ti and Al increases the surface tension of the molten metal, the droplet size increases and the droplet transfer is inhibited. Such deterioration of weldability causes a weld defect and decreases the strength of the weld zone. Therefore, in the present embodiment, the components are adjusted such that the value on the left side of the formula (3) is 0.15 or less. The value on the left side of the formula (3) is more preferably 0.10 or more.

The welding wire having the above-described chemical composition according to the present embodiment has a ferrite single-phase structure as a main phase. The diameter and the length of the welding wire are not particularly limited, and values thereof can be selected according to the purpose. The welding wire according to the present embodiment may be a solid wire made only of the ferrite-based stainless steel, or a flux-cored wire containing flux.

### EXAMPLES

Next, Examples of the present invention will be described below. Here, weld metals were formed by using welding wires having respective chemical compositions of Examples and Comparative Examples shown in Table 1 below, and oxidation resistance and high-temperature strength thereof were evaluated.

[Table 1a]

TABLE 1a

Chemical composition (mass %) (balance Fe)

| | | C | Si | Mn | P | S | Cr | Al | Ti | O |
|---|---|---|---|---|---|---|---|---|---|---|
| Example | 1 | 0.01 | 0.40 | 0.80 | 0.02 | 0.003 | 16.5 | — | 0.02 | 0.007 |
| | 2 | 0.02 | 1.95 | 0.50 | 0.02 | 0.001 | 17.7 | — | 0.01 | 0.006 |
| | 3 | 0.01 | 0.40 | 0.80 | 0.02 | 0.004 | 18.6 | — | 0.01 | 0.007 |
| | 4 | 0.04 | 0.50 | 0.60 | 0.01 | 0.002 | 19.0 | — | 0.03 | 0.006 |
| | 5 | 0.03 | 0.90 | 0.80 | 0.02 | 0.001 | 19.2 | — | 0.02 | 0.007 |
| | 6 | 0.04 | 0.50 | 0.70 | 0.02 | 0.002 | 19.0 | — | 0.01 | 0.007 |
| | 7 | 0.05 | 0.40 | 0.70 | 0.01 | 0.002 | 18.8 | — | 0.01 | 0.005 |
| | 8 | 0.01 | 0.40 | 0.80 | 0.02 | 0.001 | 16.6 | 0.01 | 0.04 | 0.007 |
| | 9 | 0.02 | 1.95 | 0.80 | 0.02 | 0.001 | 17.5 | 0.02 | 0.01 | 0.005 |
| | 10 | 0.01 | 0.40 | 0.70 | 0.02 | 0.002 | 18.7 | 0.02 | 0.01 | 0.007 |
| | 11 | 0.04 | 0.40 | 0.80 | 0.01 | 0.003 | 19.0 | 0.02 | 0.01 | 0.007 |
| | 12 | 0.03 | 0 50 | 0.80 | 0.01 | 0.001 | 19.1 | 0.04 | 0.01 | 0.007 |
| | 13 | 0.04 | 0.50 | 0.60 | 0.02 | 0.003 | 19.2 | 0.02 | 0.01 | 0.004 |
| | 14 | 0.03 | 0.40 | 0.80 | 0.02 | 0.003 | 19.0 | 0.03 | 0.01 | 0.008 |
| | 15 | 0.01 | 0.40 | 0.60 | 0.02 | 0.001 | 16.5 | — | 0.01 | 0.007 |
| | 16 | 0.02 | 1.95 | 0.80 | 0.03 | 0.001 | 17.4 | — | 0.02 | 0.007 |
| | 17 | 0.04 | 0.40 | 0.80 | 0.02 | 0.001 | 19.0 | — | 0.01 | 0.007 |
| | 18 | 0.05 | 0 40 | 0.80 | 0.02 | 0.003 | 18.8 | — | 0.01 | 0.007 |
| | 19 | 0.01 | 0.50 | 0.60 | 0.02 | 0.001 | 19.0 | 0.03 | 0.01 | 0.007 |
| | 20 | 0.02 | 0.40 | 0.80 | 0.02 | 0.003 | 19.0 | 0.01 | 0.01 | 0.007 |
| | 21 | 0.02 | 0.40 | 0.80 | 0.03 | 0.010 | 19.0 | 0.01 | 0.01 | 0.007 |
| | 22 | 0.01 | 0.60 | 0.50 | 0.02 | 0.003 | 18.8 | 0.03 | 0.03 | 0.017 |

| | | Chemical composition (mass %) (balance Fe) | | | | | Formula | Formula | Formula |
|---|---|---|---|---|---|---|---|---|---|
| | | N | Nb | Mo | W | Others | (1) | (2) | (3) |
| Example | 1 | 0.01 | — | 2.20 | — | — | 2.3 | 2.2 | 0.02 |
| | 2 | 0.01 | 1.68 | — | — | — | 2.2 | 0.0 | 0.01 |
| | 3 | 0.02 | — | — | 2.50 | — | 2.6 | 2.5 | 0.01 |
| | 4 | 0.03 | 0.45 | 2.10 | — | — | 2.7 | 2.1 | 0.03 |
| | 5 | 0.02 | 0.21 | — | 2.00 | — | 2.4 | 2.0 | 0.02 |
| | 6 | 0.01 | — | 1.90 | 1.20 | — | 3.2 | 3.1 | 0.01 |
| | 7 | 0.01 | 0.46 | 2.00 | 1.10 | — | 3.7 | 3.1 | 0.01 |
| | 8 | 0.03 | — | 2.20 | — | — | 2.3 | 2.2 | 0.05 |
| | 9 | 0.01 | 1.68 | — | — | — | 2.2 | 0.0 | 0.03 |
| | 10 | 0.02 | — | — | 2.50 | — | 2.6 | 2.5 | 0.03 |
| | 11 | 0.01 | 0.45 | 1.90 | — | — | 2.5 | 1.9 | 0.03 |
| | 12 | 0.01 | 0.22 | — | 2.10 | — | 2.4 | 2.1 | 0.05 |
| | 13 | 0.01 | — | 2.00 | 1.30 | — | 3.4 | 3.3 | 0.03 |
| | 14 | 0.02 | 0.49 | 2.00 | 1.10 | — | 3.7 | 3.1 | 0.04 |
| | 15 | 0.01 | — | 2.20 | — | 1.90 Cu | 2.3 | 2.2 | 0.01 |
| | 16 | 0.01 | 1.72 | — | — | 2.00 Cu | 2.2 | 0.0 | 0.02 |
| | 17 | 0.01 | 0.45 | 2.30 | — | 1.90 Cu | 2.9 | 2.3 | 0.01 |
| | 18 | 0 01 | 0.38 | 2.10 | 1.30 | 2.20 Cu | 3.9 | 3.4 | 0.01 |
| | 19 | 0.01 | 0.46 | 1.90 | — | 2.10 Cu | 2.5 | 1.9 | 0.04 |
| | 20 | 0.03 | 0.45 | 2.00 | — | 0.80 V | 2.6 | 2.0 | 0.02 |
| | 21 | 0.01 | 0.46 | 1.90 | — | 0.10 Ta | 2.5 | 1.9 | 0.02 |
| | 22 | 0.01 | 0.46 | 1.90 | — | 0.005 B | 2.5 | 1.9 | 0.06 |

TABLE 1b

| | | Chemical composition (mass %) (balance Fe) | | | | | | | | |
|---|---|---|---|---|---|---|---|---|---|---|
| | | C | Si | Mn | P | S | Cr | Al | Ti | O |
| Example | 23 | 0.03 | 0.40 | 0.80 | 0.03 | 0.001 | 19.0 | 0.03 | 0.01 | 0.016 |
| | 24 | 0.01 | 0.40 | 0.80 | 0.03 | 0.001 | 19.0 | 0.01 | 0.01 | 0.007 |
| | 25 | 0.01 | 0.30 | 0.60 | 0.02 | 0.004 | 19.0 | 0.04 | 0.01 | 0.007 |
| | 26 | 0.02 | 0.40 | 0.80 | 0.02 | 0.001 | 19.1 | 0.01 | 0.01 | 0.007 |
| | 27 | 0.01 | 0.40 | 0.80 | 0.02 | 0.003 | 19.0 | 0.06 | 0.01 | 0.006 |
| | 28 | 0.01 | 0.60 | 0.70 | 0.02 | 0.004 | 19.0 | 0.01 | 0.14 | 0.007 |
| | 29 | 0.02 | 0.50 | 0.60 | 0.03 | 0.004 | 19.2 | 0.05 | 0.01 | 0.007 |
| | 30 | 0.02 | 0.40 | 0.80 | 0.02 | 0.001 | 19.0 | 0.01 | 0.01 | 0.006 |
| | 31 | 0.01 | 0.40 | 0.80 | 0.01 | 0.003 | 19.0 | 0.03 | 0.01 | 0.006 |
| | 32 | 0.01 | 0.40 | 0.60 | 0.01 | 0.003 | 19.1 | 0.01 | 0.01 | 0.007 |
| | 33 | 0.01 | 0.50 | 0.80 | 0.02 | 0.004 | 19.0 | 0.03 | 0.02 | 0.007 |
| | 34 | 0.01 | 0.40 | 0.80 | 0.03 | 0.001 | 19.0 | 0.02 | 0.01 | 0.007 |
| | 35 | 0.02 | 0.40 | 0.50 | 0.02 | 0.001 | 18.9 | 0.01 | 0.01 | 0.007 |
| | 36 | 0.02 | 0.40 | 0.50 | 0.02 | 0.001 | 18.9 | 0.01 | 0.01 | 0.007 |
| | 37 | 0.02 | 0.40 | 0.50 | 0-02 | 0.001 | 18.9 | 0.02 | 0.01 | 0.007 |
| | 38 | 0.02 | 0.40 | 0.50 | 0.02 | 0.001 | 18.9 | 0.01 | 0.01 | 0.007 |
| Comparative | 1 | 0.06 | 0.40 | 0.80 | 0.03 | 0.001 | 19.0 | — | 0.01 | 0.007 |
| Example | 2 | 0.07 | 0.40 | 0.60 | 0.02 | 0.001 | 15.8 | — | 0.04 | 0.005 |
| | 3 | 0.01 | 2.10 | 0.80 | 0.02 | 0.003 | 19.0 | — | 0.01 | 0.005 |
| | 4 | 0.04 | 0.40 | 0.80 | 0.03 | 0.003 | 19.2 | 0.16 | 0.01 | 0.007 |
| | 5 | 0.03 | 0.50 | 0.80 | 0.01 | 0.004 | 19.0 | — | 0.01 | 0.004 |
| | 6 | 0.01 | 0.40 | 0.40 | 0.02 | 0.001 | 19.0 | 0.02 | 0.05 | 0.007 |

| | | Chemical composition (mass %) (balance Fe) | | | | | Formula | Formula | Formula |
|---|---|---|---|---|---|---|---|---|---|
| | | N | Nb | Mo | W | Others | (1) | (2) | (3) |
| Example | 23 | 0.02 | 0.45 | 2.00 | — | 0.006 Zr | 2.6 | 2.0 | 0.04 |
| | 24 | 0.01 | 0.45 | 1.80 | — | 0.003 Y | 2.4 | 1.8 | 0.02 |
| | 25 | 0.01 | 0.45 | — | 1.90 | 0.70 V | 2.4 | 1.9 | 0.05 |
| | 26 | 0.01 | 0.44 | — | 1.90 | 0.20 Ta | 2.4 | 1.9 | 0.02 |
| | 27 | 0.01 | 0.46 | — | 1.90 | 0.004 B | 2.5 | 1.9 | 0.07 |
| | 28 | 0.04 | 0.43 | — | 1.80 | 0.002 Zr | 2.4 | 1.8 | 0.15 |
| | 29 | 0.01 | 0.45 | — | 2.00 | 0.006 Y | 2.6 | 2.0 | 0.06 |
| | 30 | 0.05 | 0.43 | 1.00 | 1.90 | 2.00 Cu | 3.4 | 2.9 | 0.02 |
| | 31 | 0.01 | 0.45 | 1.00 | 1.00 | 1.20 V | 2.6 | 2.0 | 0.04 |
| | 32 | 0.01 | 0.46 | 1.00 | 1.90 | 0.30 Ta | 3.5 | 2.9 | 0.02 |
| | 33 | 0.01 | 0.46 | 1.00 | 0.80 | 0.006 B | 2.4 | 1.8 | 0.05 |
| | 34 | 0.01 | 0.45 | 1.20 | 1.90 | 0.005 Zr | 3.7 | 3.1 | 0.03 |
| | 35 | 0.02 | 0.45 | 1.00 | 1.00 | 0.002 Y | 2.6 | 2.0 | 0.02 |
| | 36 | 0.02 | 0.45 | 1.00 | 1.80 | 1.40 Cu | 2.3 | 1.8 | 0.03 |
| | 37 | 0.02 | 0.45 | 1.00 | — | — | 4.1 | 3.5 | 0.03 |
| | 38 | 0.02 | 0.45 | 1.00 | 0.90 | — | 2.4 | 1.9 | 0.02 |
| Comparative | 1 | 0.01 | 0.22 | 1.80 | — | — | 2.1 | 1.8 | 0.01 |
| Example | 2 | 0.01 | 0.41 | 1.60 | — | — | 2.1 | 1.6 | 0.04 |
| | 3 | 0.03 | 0.01 | 0.50 | 2.30 | — | 3.3 | 2.8 | 0.01 |
| | 4 | 0.02 | 0.45 | 2.00 | — | — | 2.6 | 2.0 | 0.17 |
| | 5 | 0.02 | 0.43 | 2.00 | 1.10 | 3.50 Cu | 3.7 | 3.1 | 0.01 |
| | 6 | 0.01 | 0.45 | 2.00 | — | 3.40 Cu | 2.6 | 2.0 | 0.07 |

### 1. Preparation of Test Piece

An alloy having the chemical composition shown in Table 1 was melted, and the obtained ingot was subjected to hot working and cold working to prepare a welding wire having a diameter φ of 1.2 mm.

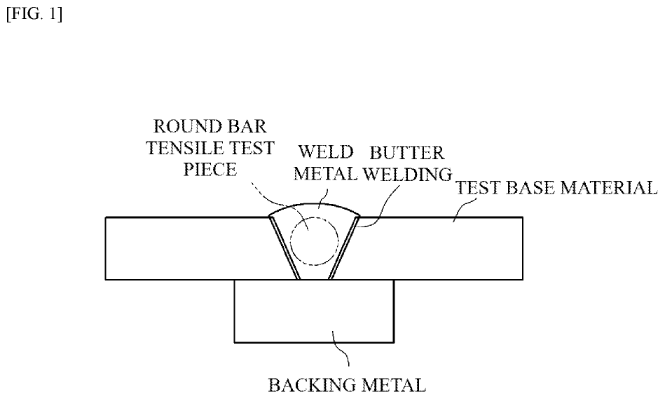

Next, as shown in FIG. 1, a commercially available SUS 430 steel plate, which had a thickness of 20 mm and had a groove surface butter welded by the welding wire, was used as a test base material, and MIG welding was performed on a groove portion by using the welding wire under the following conditions to form a weld metal.

Welding conditions: welding current of 200 A, arc voltage of 3.5 V, welding speed of 60 cm/min, interpass temperature of 150° C. to 250° C., using Ar+2 vol % O₂ as shielding gas.

Then, as shown in FIG. 1, a round bar tensile test piece for high-temperature strength evaluation was sampled from a weld zone (the weld metal) along a weld line direction in accordance with JIS Z 3111 such that the entire test piece was made of the weld metal. A test piece for oxidation resistance evaluation was also taken from the weld zone.

### 2. Evaluation

### 2-1. Oxidation Resistance

By using the test piece (size: 1.5 mm×15 mm×25 mm) sampled from the weld zone, a continuous oxidation test was performed at 900° C. for 200 hrs in the atmosphere in accordance with JIS Z 2281, and a weight gain by oxidation was measured. The evaluation criteria were as follows.

A: weight gain by oxidation: 2.5 mg/cm² or less

B: weight gain by oxidation: exceeding 2.5 mg/cm² to 4.0 mg/cm²

C: weight gain by oxidation: exceeding 4.0 mg/cm²

Here, in consideration of the oxidation resistance required for the welding wire of ferrite-based stainless steel, the case where the weight gain by oxidation was 4.0 mg/cm² or less, that is, the case of “A” or “B” was determined to be acceptable. The results were shown in Table 2 below.

### 2-2. High-temperature Strength

A high temperature tensile test was performed at 900° C. in accordance with JIS G0567 by using the round bar tensile test piece sampled from the weld zone, and tensile strength was measured. The evaluation criteria were as follows.

A: tensile strength: 40 MPa or more

B: tensile strength: 35 MPa to less than 40 MPa

C: tensile strength: less than 35 MPa

Here, the case where the tensile strength was 35 MPa or more, that is, the case of “A” or “B” was determined to be acceptable so as to ensure the strength at which the weld zone did not become a weakest portion even when SUS 444 was used as a base material. The results were shown in Table 2 below.

TABLE 2a

| | | Oxidation resistance | | High-temperature strength | |
|---|---|---|---|---|---|
| | | Evalu- | Weight gain by | Evalu- | Tensile |
| | | ation | oxidation (mg/cm²) | ation | strength (MPa) |
| Exam- | 1 | B | 3.8 | B | 36 |
| ple | 2 | B | 3.6 | B | 38 |
| | 3 | B | 3.5 | B | 39 |
| | 4 | B | 3.0 | B | 39 |
| | 5 | B | 2.9 | B | 38 |
| | 6 | B | 3.9 | B | 39 |
| | 7 | A | 2.5 | A | 40 |
| | 8 | B | 3.8 | B | 37 |
| | 9 | B | 3.6 | B | 39 |
| | 10 | B | 3.5 | A | 40 |
| | 11 | B | 3.0 | A | 40 |
| | 12 | B | 2.9 | B | 39 |
| | 13 | B | 3.9 | A | 40 |
| | 14 | A | 2.5 | A | 41 |
| | 15 | A | 2.5 | A | 40 |
| | 16 | A | 2.3 | A | 44 |
| | 17 | A | 2.0 | A | 45 |
| | 18 | A | 2.2 | A | 44 |
| | 19 | A | 1.5 | A | 45 |
| | 20 | A | 2.0 | A | 42 |
| | 21 | A | 1.5 | A | 41 |
| | 22 | A | 1.4 | A | 40 |
| | 23 | A | 2.0 | A | 44 |
| | 24 | A | 1.2 | A | 43 |
| | 25 | A | 1.7 | A | 42 |
| | 26 | A | 1.5 | A | 41 |
| | 27 | A | 1.4 | A | 40 |
| | 28 | A | 1.2 | B | 39 |
| | 29 | A | 1.3 | A | 40 |
| | 30 | A | 1.5 | A | 45 |
| | 31 | A | 1.7 | A | 42 |
| | 32 | A | 1.5 | A | 41 |
| | 33 | A | 1.4 | A | 40 |

TABLE 2b

| | | Oxidation resistance | | High-temperature strength | |
|---|---|---|---|---|---|
| | | Evalu- | Weight gain by | Evalu- | Tensile |
| | | ation | oxidation (mg/cm²) | ation | strength (MPa) |
| Exam- | 34 | A | 1.2 | B | 39 |
| ple | 35 | A | 1.3 | A | 40 |
| | 36 | A | 1.5 | A | 45 |
| | 37 | A | 1.7 | B | 39 |
| | 38 | A | 1.6 | B | 39 |
| Com- | 1 | B | 3.8 | C | 25 |
| para- | 2 | C | 6.0 | C | 26 |
| tive | 3 | B | 3.8 | C | 30 |
| Exam- | 4 | A | 1.8 | C | 33 |
| ple | 5 | A | 2.2 | C | 30 |
| | 6 | A | 1.5 | C | 30 |

From the evaluation results in Table 2, the following can be seen.

Comparative Example 1 is an example in which C is added in an amount exceeding the upper limit of 0.05% in the present invention, and does not satisfy the condition of the formula (1) related to the high-temperature strength. In Comparative Example 1, the tensile strength at a high temperature is low.

Comparative Example 2 is an example in which C is added in an amount exceeding the upper limit of 0.05% in the present invention and Cr is added in an amount less than the lower limit of 16.0% in the present invention, resulting in a large weight gain by oxidation and low oxidation resistance. Comparative Example 2 does not satisfy the condition of the formula (1) related to the high-temperature strength, and the value of the tensile strength at a high temperature is also low.

Comparative Example 3 is an example in which Si is added in an amount exceeding the upper limit 2.00% in the present invention. Excessive Si deteriorates toughness of the weld zone. Therefore, in Comparative Example 3, the value of the tensile strength at a high temperature is low.

Comparative Example 4 is an example in which Al is added in an amount exceeding the upper limit of 0.15% in the present invention, and does not satisfy the condition of the formula (3) related to the weldability. Addition of an appropriate amount of Al contributes to refinement of the crystal grain, but in the case where Al is excessively added and the condition of the formula (3) related to the weldability is not satisfied, a welding defect is likely to occur. In Comparative Example 4, the value of tensile strength at a high temperature is low.

Comparative Examples 5 and 6 are examples in which Cu is added in an amount exceeding the upper limit of 3.0% in the present invention. Excessive addition of Cu deteriorates toughness and ductility of the weld zone. Therefore, in Comparative Example 5 and Comparative Example 6, the value of the tensile strength at a high temperature is low.

As described above, in each Comparative Example, the evaluation of at least one of the oxidation resistance and high-temperature strength is unacceptable (“C”).

In contrast, in Examples 1 to 38 in which the chemical composition of the welding wire is within the range of the present invention, both of the oxidation resistance and the high-temperature strength are evaluated as acceptable (“A” or “B”).

For example, when focusing on Examples 1 to 7, it is understood that the value of the tensile strength is large and the high-temperature strength is improved in the case where the value on the left side of the formula (1) related to the high-temperature strength is large.

In Examples 8 to 14 in which Al was added, the value of the tensile strength is larger than that in Examples 1 to 7 in which no Al was added, and the effect of improving the high-temperature strength by adding Al is recognized.

In Examples 15 to 18 in which Cu was added, both the oxidation resistance and the high-temperature strength are improved as compared with Example 1 to 7 in which no Cu was added.

In Examples 19 to 36 in which any of Cu, B, V, Ta, Zr, and Y was added together with Al, both the oxidation resistance and the high-temperature strength are improved as compared with Examples 1 to 7.

Although the present invention has been described in detail above, the present invention is not limited to the above-described embodiments and Examples, and various modifications can be made without departing from the scope of the present invention.

### INDUSTRIAL APPLICABILITY

According to the present invention, a ferrite-based stainless steel welding wire excellent in high-temperature strength and oxidation resistance can be provided.

The present application is based on a Japanese patent application (Japanese Patent Application No. 2020-203610) filed on Dec. 8, 2020, and the contents thereof are incorporated herein by reference.

1. A ferrite-based stainless steel welding wire, comprising, in terms of mass %:
C: 0.001% to 0.050%;
Si: 0.01% to 2.00%;
Mn: 0.01% to 1.50%;
P: 0.030% or less;
S: 0.010% or less;
Cr: 16.0% to 25.0%;
Ti: 0.001% to 0.150%;
O: 0.020% or less;
N: 0.050% or less; and
one or two or more selected from
Nb: 0.01% to 1.80%,
Mo: 0.01% to 3.60%, and
W: 0.01% to 3.60%,
with the balance being Fe and inevitable impurities, and
satisfying the following formulae (1), (2), and (3), in which in the formulae, [ ] represents a content in terms of mass % of an element in [ ]:
[Nb]+[Mo]+[W]+0.25[Si]≥2.2 Formula (1);
[Mo]+[W]≤3.6 Formula (2); and
[Ti]+[Al]≤0.15 Formula (3).

2. The ferrite-based stainless steel welding wire according to claim 1, further comprising, in terms of mass %, any one or more of:
Cu: 0.1% to 3.0%,
B: 0.01% or less,
V: 0.1% to 2.0%,
Ta: 0.05% to 0.50%,
Zr: 0.001% to 0.010%, and
Y: 0.001% to 0.010%.

3. The ferrite-based stainless steel welding wire according to claim 1, wherein the N satisfies 0.0049 mass % or less.

4. The ferrite-based stainless steel welding wire according to claim 1, wherein the Cr satisfies 17.0 mass % to 19.2 mass %.

5. The ferrite-based stainless steel welding wire according to claim 1, wherein the C satisfies 0.042 mass % or less.

6. The ferrite-based stainless steel welding wire according to claim 1, wherein the Al satisfies 0.001 mass % to 0.150 mass %.
